(19) United States
(12) Patent Application Publication
(10) Pub. No.: US 2025/0062834 A1
(43) Pub. Date: Feb. 20, 2025

(54) OPTICAL HALF-ADDER AND AVERAGING DATA CHANNELS USING NONLINEAR WAVE MIXING

(71) Applicant: University of Southern California, Los Angeles, CA (US)

(72) Inventors: Amir Minoofar, Los Angeles, CA (US); Jonathan L. Habif, Waltham, MA (US); Hao Song, Los Angeles, CA (US); Alan E. Willner, Los Angeles, CA (US); Kaiheng Zou, Los Angeles, CA (US)

(21) Appl. No.: 18/807,683

(22) Filed: Aug. 16, 2024

Related U.S. Application Data
(60) Provisional application No. 63/533,543, filed on Aug. 18, 2023.

(51) Int. Cl. H04B 10/556; H04B 10/67

(52) U.S. Cl. CPC H04B 10/5561; H04B 10/677

(57) ABSTRACT

Aspects of this technical solution can include obtaining, by a first device, a first data stream carrying a first two-bit number mapped to one or more phase-encoded optical signals, obtaining, by a second device, a second data stream carrying a second two-bit number mapped to the one or more phase-encoded optical signals, encoding, based on the one or more quadrature-phase-shift-keying phases, the first data stream, and the second data stream in a 4-phase-encoded modulation format, performing the average operation on the two transmitted optical signals, and multicasting the result of the average operation to the wavelength of the two transmitted optical channels by nonlinear wave mixing.

### CROSS-REFERENCE TO RELATED APPLICATION

This application claims the benefit under 35 U.S.C. 119 (e) of U.S. Provisional Ser. No. 63/533,543, filed Aug. 18, 2023, the contents of which is hereby incorporated by reference into the present disclosure.

### STATEMENT REGARDING FEDERALLY SPONSORED RESEARCH OR DEVELOPMENT

This invention was made with government support under Grant Numbers HR001120C0088 and HR001120C0174, awarded by the Defense Advanced Research Projects Agency (DARPA). The government has certain rights in the invention.

### SUMMARY

One aspect of the present disclosure is directed toward a method. The method can include receiving, by an optical half-adder, an optical signal according to one or more phase-encoded inputs and transforming, by the optical half-adder, the optical signal according to a carry operation and a sum operation.

In some embodiments, the optical signal includes a first data stream carrying a first two-bit number mapped to one or more first quadrature-phase-shift-keying phases. The optical signal can include a second data stream carrying a second two-bit number mapped to one or more second quadrature-phase-shift-keying phases. The optical signal can be modulated at a rate of 10-Gigabaud. The optical signal can be modulated at a rate of 20-Gigabaud.

In some embodiments, the method further includes generating a mapping of quaternary base numbers {0,1,2,3} to a pair of quadrature-phase-shift keying signals A and B with four phase levels of

$$( \frac{- 3 π}{16} , \frac{π}{16} , \frac{5 π}{16} , \frac{9 π}{16} ) ,$$

generating, based on each of the pair of quadrature-phase-shift keying signals, a pair of phase-conjugate signals (A* and B*) with four phase levels of

$$( \frac{3 π}{16} , \frac{- π}{16} , \frac{- 5 π}{16} , \frac{- 9 π}{16} ) ,$$

and generating, based on the pair of quadrature-phase-shift keying signals, a pair of phase-doubled signals (A² and B²) with four phase levels of

$$( \frac{π}{4} , \frac{3 π}{4} , \frac{5 π}{4} , \frac{7 π}{4} )$$

to form two optical signals S_{A} (A, A*, A²) and S_{B} (B, B*, B²). The method can further include loading, by an arbitrary waveform generator, data streams of two data channels, and modulating, by an in-phase and quadrature modulator, the data streams of the two data channels on two optical carriers as phase-encoded optical signals. The optical half-adder can compute a sum and carry via non-linear wave mixing of the optical signals (S_{A} and S_{B}) using a periodically poled lithium niobate waveguide.

Another aspect of the present disclosure is directed towards a method. The method can include obtaining, by a first device, a first data stream carrying a first two-bit number as a 4-phase encoded channel with phase levels of

$${φ}_{A} / 2 = ( 0 , \frac{π}{4} , \frac{π}{2} , \frac{3 π}{4} ) ,$$

obtaining, by a second device, a second data stream carrying a second two-bit number as a 4-phase encoded channel with phase levels of

$${φ}_{B} / 2 = ( 0 , \frac{π}{4} , \frac{π}{2} , \frac{3 π}{4} ) ,$$

encoding, based on one or more quadrature-phase-shift-keying phases, the first data stream and the second data stream as four-phase-encoded optical data channels, computing, by an optically-assisted operation when nonlinear wave mixing the first and the second data streams, an average operation on encoded first and second data streams, and multicasting, by nonlinear wave mixing, the result of the average operation.

In some embodiments, computing the average operation of the first and the second data streams can include summing the phase levels of two optical data channels through a highly nonlinear fiber. The result of the average operation can be multicast at one or more original input signal wavelengths using a periodically poled lithium niobate waveguide and broadcast back to one or more individual nodes. The result of the average operation can be multicast to wavelengths of the first and second data streams. The result of the average operation can be a third data stream carrying a three-bit number and comprising a resolution greater than a resolution corresponding to the first or second data streams. The result of the average operation can be a 7-phase-encoded signal representing a three-bit number. The method can further include detecting, using a coherent receiver, one or more different phase levels, and corresponding bit streams of the 7-phase-encoded signal.

Another aspect of the present disclosure is directed toward a system. The system can include at least one memory and at least one processor configured to obtain a first data stream carrying a first two-bit number mapped to one or more quadrature-phase-shift-keying phases, obtain a second data stream carrying a second two-bit number mapped to the one or more quadrature-phase-shift-keying phases, encode, based on the one or more quadrature-phase-shift-keying phases, the first data stream and the second data stream in a 4-phase-shift-keying (4-PSK) modulation format, transform the first and the second data streams to an average operation, and multicasting a result of the average operation.

In some embodiments, transforming the first and the second data streams to the average operation can be performed by a highly nonlinear fiber (HNLF). Multicasting the result of the average operation can be performed by a periodically poled lithium niobate (PPLN).

### BRIEF DESCRIPTION OF THE DRAWINGS

These and other aspects and features of the present implementations are depicted by way of example in the figures discussed herein. Present implementations can be directed to, but are not limited to, examples depicted in the figures discussed herein.

FIG. 1 illustrates an example processor system in accordance with present implementations.

FIG. 2 illustrates another example processor system in accordance with present implementations.

FIG. 3 illustrates example transmitter nodes of the example processing system of FIG. 1.

FIG. 4 illustrates an example processing node of the example processing system of FIG. 1.

FIG. 5 illustrates an example summation stage of the example processing node of FIG. 4.

FIG. 6 illustrates an example multicasting stage of the example processing node of FIG. 4.

### DETAILED DESCRIPTION

Aspects of this technical solution are described herein with reference to the figures, which are illustrative examples of this technical solution. The figures and examples below are not meant to limit the scope of this technical solution to the present implementations or a single implementation. Other implementations following present implementations are possible, for example, by an interchange of some or all of the described or illustrated elements. Where certain elements of the present implementations can be partially or fully implemented using known components, only those portions of such known components that are necessary for an understanding of the present implementations are described, and detailed descriptions of other parts of such known components are omitted to not obscure the present implementations. Terms in the specification and claims are to be ascribed no uncommon or special meaning unless explicitly set forth herein. Further, this technical solution and the present implementations encompass present and future known equivalents to the known components referred to herein by way of description, illustration, or example.

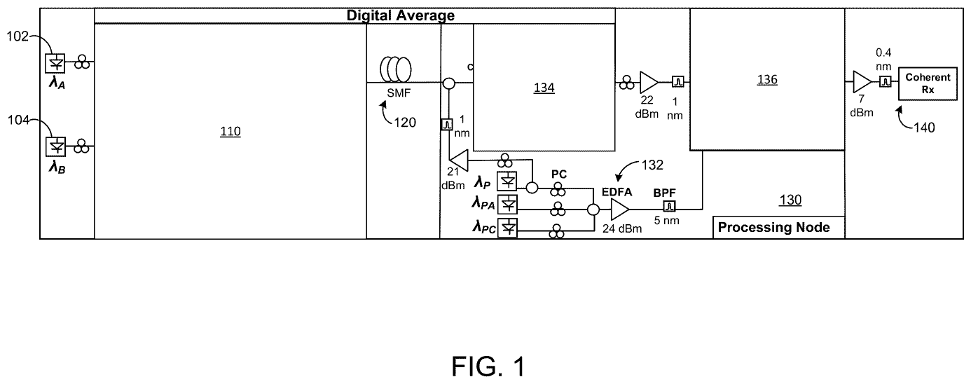

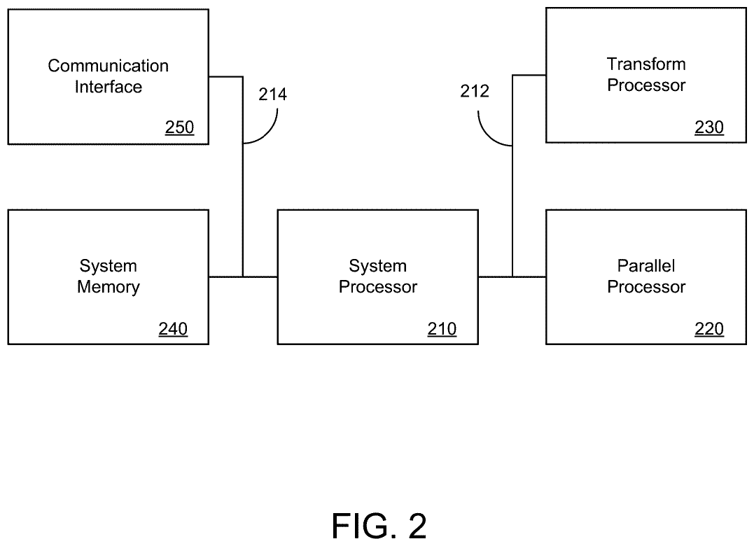

Appendices A-B are appended to this specification and are hereby incorporated by reference herein into the specification for all intents and purposes. The systems, methods, operations, flows, and graphical user interfaces depicted in any one of Appendices A-B can be performed using the systems, components, or operations depicted in FIGS. 1 and 2.

Appendix A illustrates an optical half-adder for 4-ary phase-encoded inputs. The input quaternary base numbers (0,1,2,3) are represented by four phase levels using 4-PSK signals A (B). Meanwhile, the corresponding conjugate and square signals A*, A² (B*, B²) carrying the same data are generated. To generate the Sum, the phase of A and B are accumulated together through nonlinear wave mixing and converted to a new 4-PSK signal. The corresponding four phase levels represent the resultant Sum (0,1,2,3).

Appendix B illustrates an optical signal processing (OSP) system for computing the average of two 4-phase-encoded signals. Generally, to perform the average operation, two arithmetical operations must be performed: division and summation.

Aspects of this technical solution can be implemented by one or more processors, as discussed herein. For example, various computational processes or calculations can be performed at least partially by one or more processor devices or communicated at least partially with one or more processor devices, as discussed herein. This technical solution is not limited to the processor devices discussed herein or implementations incorporating the processor devices discussed herein. Aspects of this technical solution can be optimized for execution on or by one or more processors as discussed herein to provide one or more technical improvements as discussed herein.

FIG. 1 illustrates a processor system 100 in accordance with present implementations. As illustrated by way of example in FIG. 1, an example processing system 100 can include an experimental setup including a first laser source λ_{A} 102 at a first source frequency (e.g., an original input frequency), a second laser source λ_{B} 104 at a second source frequency (e.g., an original input frequency), one or more transmitters 110 (e.g., one or more transmitter nodes), a single mode fiber 120 (SMF), one or more processing nodes 130, and a coherent receiver 140 (Coherent Rx). For example, the processor system 100 can include an In-phase and Quadrature modulation (IQ mod), an arbitrary waveform generator 112 (AWG), a wavelength division multiplexer (λ-Mux), a wavelength division demultiplexer 114 (λ-Demux), an erbium-doped fiber amplifier 132 (EDFA), a band-pass filter (BPF), a summation stage 134 including a highly nonlinear fiber (HNLF), a multicasting stage 136 including a periodically poled lithium niobate (PPLN), and a coherent receiver 140 (Coherent Rx).

The processor system 100 can calculate a digital average. For example, two users (A, B) located at different locations (e.g., geographical locations), can each send distinct digital data streams (D_{A}, D_{B}). The digital data streams can include two-bit numbers. These binary data streams can then be phase encoded on separate optical carrier waves. The digital average function generally involves two arithmetical operations: division and summation. Overall, the data streams can undergo (1) phase encoding and division, (2) summation, and (3) multicasting via the processing system 100. Phase-encoding can be combined with division at the transmitter 110. The data streams (e.g., a first data stream and a second data stream) carrying a two-bit number can be obtained as a 4-phase encoded channel with four phase levels of φ_{A}/2 or φ_{B}/2=(0, π/4, π/2, 3π/4) by the transmitter 110. The data streams can then be phase encoded via quadrature-phase-shift-keying phases (e.g., 4-PSK). Resulting optical signals (S_{A}, S_{B}) following phase encoding can then be transmitted to the processing node 130. The processing node 130 can include two operations: summation and multicasting. The summation can include computing an average operation of phase-encoded data streams via nonlinear wave mixing. The nonlinear wave mixing can be an optically-assisted operation. Accordingly, the addition of input signals (S_{A}, S_{B}) with halved phase levels representing 2-bit numbers (0,0.5, 1,1.5) can result in another 7-phase-encoded signal (R) with phase levels of (0, π/4, . . . , 5π/4, 3π/2) representing a 3-bit number. Subsequently, the result can be multicast into two copies (R_{A}, R_{B}) at the original signal wavelengths (e.g., the distinct digital data streams) to be used for the next processing round of the users. For example, the result of the average operation can be multicast by nonlinear wave mixing. The coherent receiver 140 can be used to detect the 7-phase-encoded outputs. Different phase levels and their corresponding bit streams can be decoded using offline signal processing.

The processor system 100 can use nonlinear wave mixing to perform the digital average. Optical waves of the two 4-phase-encoded inputs (S_{A}, S_{B}) over one symbol duration can be formulated as E_{A}∝exp(j(2πf_{A}t+φ_{A}/2)) and E_{B}∝exp (j(2πf_{B}t+φ_{B}/2)), where f_{A} or f_{B} are the carrier frequencies. The non-degenerate four-wave mixing (FWM) process in the HNLF between the inputs and a dummy pump (P) can generate an idler (R). The result is represented as E_{R}∝exp(j(2πf_{R}t+φ_{R})) at the frequency of f_{R}=f_{A}+f_{B}−f_{P} having the phase of φ_{R}(t)=φ_{A}(t)/2+φ_{B}(t)/2−φ_{P}. Subsequently, using the PPLN waveguide, (i) sum frequency generation (SFG) process between the average result (R) and a dummy pump (Pc) and (ii) the difference frequency generation (DFG) processes with each dummy pump (P_{A}, P_{B}) result in two outputs (R_{A}, R_{B}). The dummy pump can be a light source used for testing. The optical field of the output may be expressed as E_{R}_{_{A}}∝exp(j(2πf_{A}t+φ_{R}) and E_{R}_{_{B}}∝exp(j(2πf_{B}t+φ_{R})), respectively.

In various embodiments, the number of bits of input/output signals of the processor system 100 can increase by using higher-order phase-encoded signals (e.g., using 8-phase-encoded inputs with each symbol representing 3-bit numbers, resulting in 15-phase-encoded output with each symbol representing 4-bit numbers).

As illustrated by way of example in FIG. 2, an example processing system 200 can include a system processor 210, a parallel processor 220, a transform processor 230, a system memory 240, a communication interface 250, and one or more optical link(s) 260. At least one of the examples of processing system 200 and the system processor 210 can include a processor bus 212 and a system bus 214. In some examples, system 200 is configured to process one or more phase-encoded optical signals, which can include generating an average in the optical domain. In some examples, the system can include a processing node (e.g., an optical network, or portion thereof, that includes at least part of optical link 260), described in greater detail below, configured to compute the summation of two phase-encoded optical signals, for example, at an optical interface that connects the output of optical link 260 to the inputs of the processing node. The result generated by the processing node can be used in further processing, including, for example, optical-to-digital conversion and subsequent digital signal processing performed by one or more of the processors, digital logic, etc., described herein.

The system processor 210 can execute one or more instructions. The system processor 210 can obtain one or more instructions via at least one of the system memory 240 and the communication interface 250. The system processor 210 can include an electronic processor, an integrated circuit, or any combination thereof, for example, including one or more of digital logic, analog logic, digital sensors, analog sensors, communication buses, volatile memory, nonvolatile memory, or any combination thereof. The system processor 210 can include, but is not limited to, at least one microcontroller unit (MCU), a microprocessor unit (MPU), a central processing unit (CPU), a graphics processing unit (GPU), a physics processing unit (PPU), an embedded controller (EC), or any combination thereof. The system processor 210 can include memory operable to store (e.g., configured for storing) one or more instructions for operating components of the system processor 210 and operating components operably coupled to the system processor 210. The one or more instructions can include at least one of firmware, software, hardware, operating systems, embedded operating systems, or any combination thereof.

The processor bus 212 can communicate one or more instructions, signals, conditions, states, or any combination thereof, for example, between one or more of the system processor 210, the parallel processor 220, and the transform processor 230. The system bus 214 can communicate one or more instructions, signals, conditions, states, or any combination thereof, for example, between one or more of the system processor 210, the system memory 240, and the communication interface 250. The processor bus 212 and the system bus 214 can each include one or more channels, lines, traces, or any combination thereof, for example, that can perform digital or analog communication. In some examples, the processor bus 212 can include one or more optical channels for or interface(s) in an optical network (e.g., optical link 260) or any portion of the optical components or individual elements thereof.

Similarly, in some examples, the system bus 214 can include one or more optical channels for, or interface(s) included in, an optical network (e.g., optical link 260) and any portion of the corresponding components included therein. The system bus 214 may be configured for, or may optically couple with, one or more optical channels of the optical link 260 (e.g., two data channels processed during the operation of optical link 260). The system bus 214 can carry one or more optical signals associated with the operation of optical link 260, which may include one or more optical signals for an optical link, including any optical signals an optical link receives as input generated by its operation or provides as an output. The system bus 214 may be configured for, or aid in, broadcasting the optical signal output by a processing node (e.g., a processing node included as a component of optical link 260, system bus 214, system processor 210, communication interface 250, etc., and any combination thereof) to multicast the result (e.g., the digital average) to the optical link 260 as input(s) used in subsequent operations of system 200, or subsequent computation of an average in the optical domain. Any devices or components associated with the processor bus 212 or the system bus 214 can also be associated with, integrated with, supplemented by, or complemented by, for example, the system processor 210 or any component thereof.

The parallel processor 220 can execute one or more instructions concurrently, simultaneously, or any combination thereof. The parallel processor 220 can execute one or more instructions in a parallelized order in accordance with one or more parallelized instruction parameters. In some implementations, parallelized instruction parameters include one or more sets, groups, ranges, types, or any combination thereof associated with various instructions. The parallel processor 220 can include one or more execution cores variously associated with various instructions. The parallel processor 220 can include one or more execution cores variously associated with various instruction types or any combination thereof. The parallel processor 220 can include an electronic processor, an integrated circuit, or any combination thereof, for example, including one or more of digital logic, analog logic, communication buses, volatile memory, nonvolatile memory, or any combination thereof. The parallel processor 220 can include, but cannot be limited to, at least one GPU, physics processing unit, embedded controller, gate array, programmable gate array, FPGA, ASIC, or any combination thereof. Any electrical, electronic, or like devices or components associated with the parallel processor 220 can also be associated with, integrated with, supplemented by, complemented by, or any combination thereof, the system processor 210 or any component thereof.

One or more cores of the parallel processor 220 can be linked with one or more parallelizable operations in accordance with one or more metrics, engines, models, or any combination thereof of the technical solution discussed herein. For example, parallelizable operations can include processing portions of an image, video, waveform, audio waveform, processor thread, one or more layers of a learning model, one or more metrics of a learning model, one or more models of a learning system, or any combination thereof. For example, a predetermined number or set of one or more particular cores of the parallel processor 220 can be associated exclusively with one or more distinct sets of corresponding metrics, engines, models, or any combination thereof in accordance with the technical solution discussed herein. A first core of the parallel processor 220 can be assigned to, associated with, configured to, or fabricated to execute instructions or operations corresponding to a portion or subset of the instructions or operations of the technical solution discussed herein. Thus, the parallel processor 220 can parallelize execution across one or more metrics, engines, models, or any combination thereof.

The transform processor 230 can execute one or more instructions associated with one or more predetermined transformation processes. For example, a transformation process can include a Fourier transform, matrix operation, calculus operation, combinatoric operation, trigonometric operation, geometric operation, encoding operation, decoding operation, compression operation, decompression operation, image processing operation, audio processing operation, speech processing operation, or any combination thereof. The transform processor 230 can execute one or more transformation processes in accordance with one or more transformation instruction parameters. For example, a transformation instruction parameter can include an instruction to link the transform processor 230 with a predetermined transformation process. The transform processor 230 can be linked with one or more transformation processes. The transform processor 230 can include a plurality of transform processors 230 associated with various predetermined transformation processes. The transform processor 230 can include a plurality of transformation processing cores associated with, configured to execute, fabricated to execute, or any combination thereof, a predetermined transformation process. For example, the transform processor 230 can include a first processor or core configured to execute a first transformation process and a second processor or core configured to execute a second transformation process. The transform processor 230 can include an electronic processor, an integrated circuit, or any combination thereof, including one or more of digital logic, analog logic, communication buses, volatile memory, nonvolatile memory, or any combination thereof. The transform processor 230 can include but is not limited to, at least one GPU, PPU), EC, gate array, PGA, FPGA, ASIC, or any combination thereof having an architecture distinct from the system processor 210 and the parallel processor 220. Any electrical, electronic, or like devices or components associated with the transform processor 230 can also be associated with, integrated with, supplemented by, or complemented by, for example, the system processor 210 or any component thereof.

The transform processor 230 can execute one or more predetermined transform processes in accordance with one or more metrics, engines, models, or any combination thereof of the technical solution discussed herein. In some implementations, a predetermined transform process of the transform processor 230 can be associated with one or more corresponding metrics, engines, models, or any combination thereof of the technical solutions discussed herein. For example, the transform processor 230 can be assigned to, associated with, configured to, or fabricated to execute a matrix operation associated with one or more engines, metrics, models, or any combination thereof of the technical solutions discussed herein. Thus, the transform processor 230 can centralize, optimize, or coordinate, for example, the execution of a transform process across one or more metrics, engines, models, or any combination thereof of the technical solutions discussed herein. The transform processor 230 can be fabricated or configured to execute a particular transform process with a minimized or optimized device factor. For example, a device factor can include a physical logic footprint, logic complexity, heat expenditure, heat generation, power consumption, or any combination thereof concerning at least one metric, engine, model, or any combination thereof.

The system memory 240 can store data associated with the example processing system 200. The system memory 240 can include a hardware memory device to store binary data, digital data, or any combination thereof. The system memory 240 can include one or more electrical components, electronic components, programmable electronic components, reprogrammable electronic components, integrated circuits, semiconductor devices, flip flops, arithmetic units, or any combination thereof. The system memory 240 can include at least one of a non-volatile memory device, a solid-state memory device, a flash memory device, and a NAND memory device. The system memory 240 can include one or more addressable memory regions disposed on one or more physical memory arrays. For example, a physical memory array can include a NAND gate array disposed on a particular semiconductor device, integrated circuit device, printed circuit board device, or any combination thereof.

The communication interface 250 can communicatively couple at least the system processor 210 to an external device. For example, an external device can include but is not limited to a component of this technical solution, a smartphone, mobile device, wearable mobile device, tablet computer, desktop computer, laptop computer, cloud server, local server, or any combination thereof. The communication interface 250 can communicate one or more instructions, signals, conditions, states, or any combination thereof between one or more of the system processor 210 and the external device. The communication interface 250 can include one or more channels, lines, traces, or any combination thereof, for example, that can perform digital or analog communication. For example, the communication interface 250 can include one or more serial or parallel communication lines among multiple communication lines of a communication interface. The communication interface 250 can include one or more wired or wireless communication devices, systems, protocols, or interfaces. The communication interface 250 can include one or more logical or electronic devices, including but not limited to integrated circuits, logic gates, flip flops, gate arrays, programmable gate arrays, or any combination thereof. The communication interface 250 can include one or more telecommunication devices, including but not limited to antennas, transceivers, packetizers, wired interface ports, or any combination thereof. Any electrical, electronic, or like devices or components associated with the communication interface 250 can also be associated with, integrated with, supplemented by, or complemented by the system processor 210 or any component thereof.

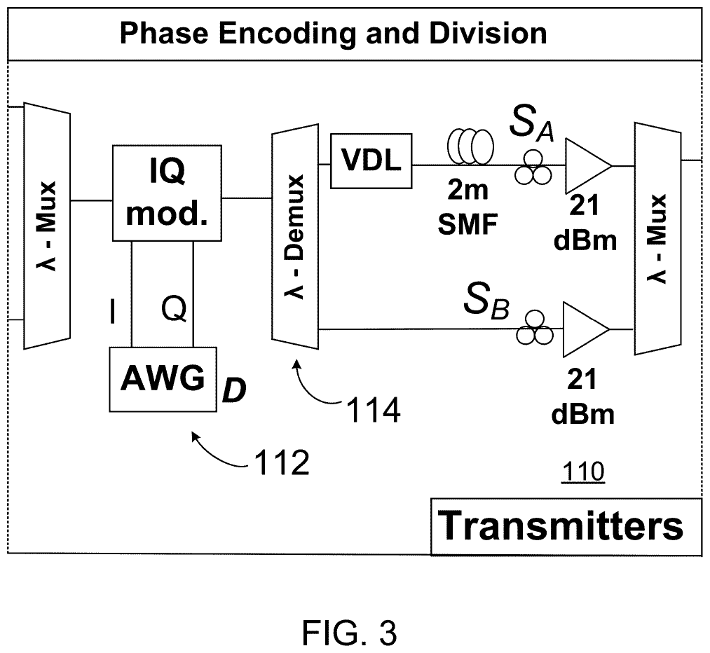

FIG. 3 illustrates an example transmitter node 110 of the example processing system 100 of FIG. 1. The processing system 100 can average data channels and transform a first and second data stream into an average operation. The first source frequency from the first laser source λ_{A} 102 and the second source frequency from the second laser source λ_{B} 104 can correspond to data (e.g., signals, data streams). The data streams can be input into the transmitter node 110. The transmitter node 110 can phase encode and divide the first and second source frequencies. For example, the transmitter node 110 can phase encode data streams of the first source frequency and the second source frequency at four phase levels of φ_{A}/2 or φ_{B}/2=(0, π/4, π/2, 3π/4). Resulting optical signals (S_{A}, S_{B}) can then be transmitted.

The data streams are first polarization controlled, which can be encoded into an electrical signal by first multiplexing (e.g., combining) the data streams into a single data stream via a first λ-Mux. Polarization control can be performed by a polarization controller which can align a polarization state of interacting signals. The single data stream can then be modulated via the IQ mod coupled to the AWG 112. The AWG 112 can phase encode the single data stream at 0, π/4, π/2, 3π/4 and divide the single data stream into a first and a second data stream (e.g., S_{A}, S_{B}). For example, electrical data is input into the IQ mod coupled to the AWG 112, and the IQ mod coupled to the AWG 112 outputs optical data. The first and the second data streams are then demultiplexed using the A-Demux 114. To make the two data streams independent (e.g., decorrelated), the first data stream can be delayed via a variable delay line (VDL) and a two-meter single-mode fiber (SMF). The VDL can minimize symbol skew time between the two data streams. A second data stream is not delayed and can be directly polarized, controlled, and amplified into a second λ-Mux. Following input of the second data stream, the first data stream is then amplified and input into the second λ-Mux.

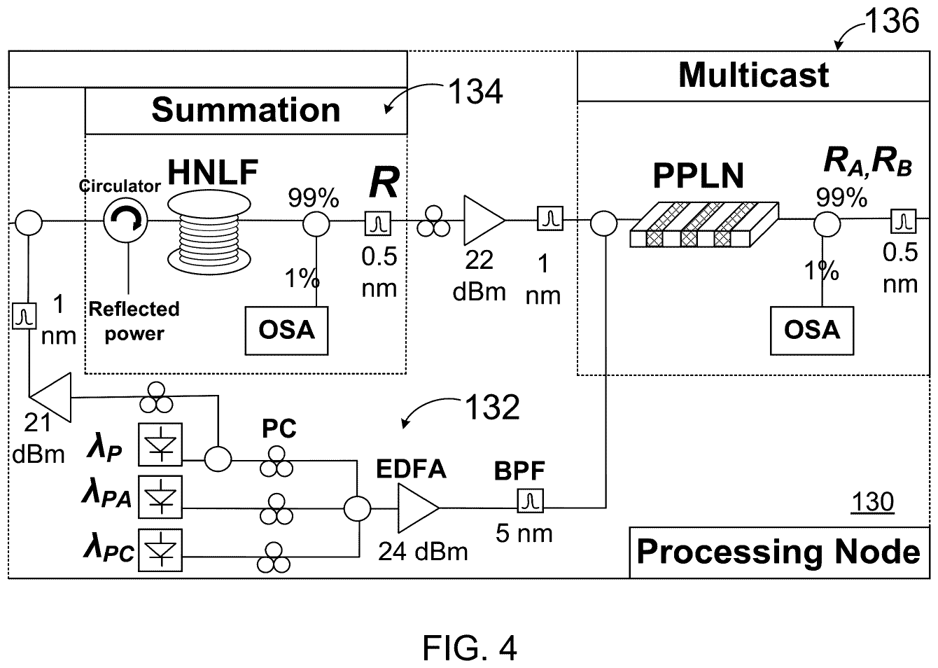

FIG. 4 illustrates an example processing node 130 of the example processor system 100 of FIG. 1. The first and second data streams can be sent to processing node 130 from transmitter node 110 via SMF 120. The processing node 130 can include a third laser source λ_{P}, a fourth laser source λ_{PA}, and a fifth laser source λ_{PC}. The processing node 130 can include the summation stage 134 and the multicasting stage 136. The third laser source λ_{P} can be coupled to both the summation stage 134 and the multicasting stage 136, while the fourth laser source λ_{PA} and a fifth laser source λ_{PC} are coupled to the multicasting stage 136. A third source frequency of the third laser source λ_{P} first travels through a polarization controller, an amplifier, and a coupler before reaching the summation stage 134. The third source frequency, a fourth source frequency of the fourth laser source λ_{PA} and a fifth source frequency of the fifth laser source λ_{PC} travel through polarization controllers, the EDFA 132, and the BPF before reaching the multicasting stage 136. The EDFA 132 can adjust the power levels of the third, fourth, and fifth source frequencies. The third laser source λ_{P}, the fourth laser source λ_{PA}, and the fifth laser source λ_{PC} can be used for wave mixing for summation stage 134 and the multicasting stage 136.

In various implementations, data stream division occurs in the processing node 130 by halving the phase of optical signals using an all-optical phase-sensitive approach.

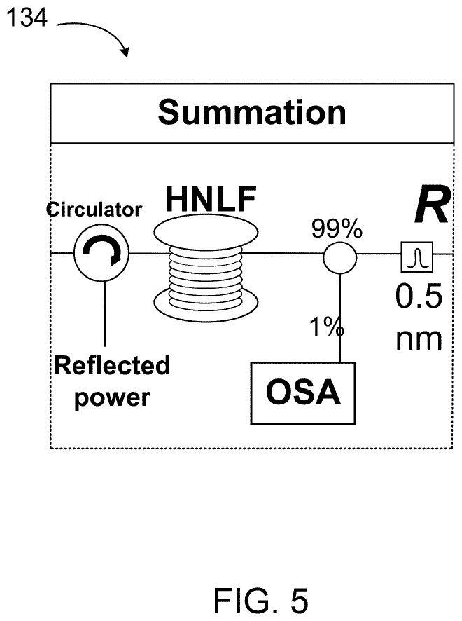

FIG. 5 illustrates an example summation stage 134 of the example processing node 130 of FIG. 4. The average operation of the first and the second data stream can include summing phase levels of two optical data channels through a non-linear fiber (e.g., HNLF). The summation stage 134 can include a circulator to reflect power, the HNLF, and an optical spectrum analyzer (OSA). The HNLF can be used to sum phases of the phase-encoded first and second data streams (S_{A}, S_{B}) by using four-wave mixing (FWM) with a continuous wave (CW) pump to achieve the digital average into a summation data stream. The HNLF can have the following characteristics: a length of 520 m, a zero-dispersion wavelength (ZDW) of ˜ 1555 nm, and a nonlinear coefficient of 20 W⁻ⁱ·km⁻¹. Following the HNLF, the summation data stream can be input into the OSA and a coupler to produce a digital average result (R). The digital average result equals (D_{A}+D_{B})/2.

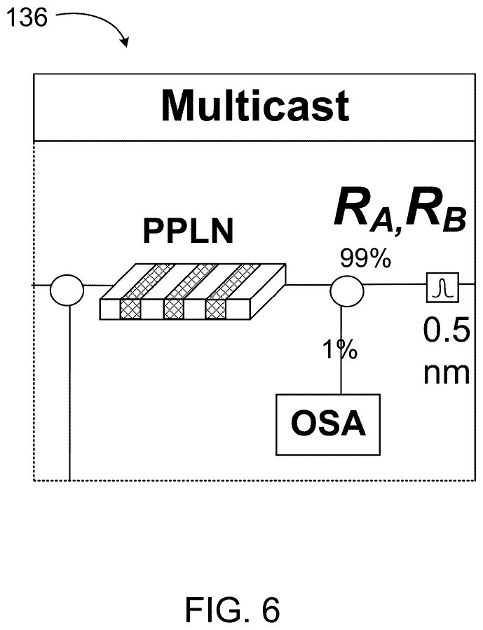

FIG. 6 illustrates multicasting stage 136 of the example processing node 130 of FIG. 4. The digital average result can be filtered, amplified, and sent to the PPLN waveguide along with the third, fourth, and fifth source frequencies. The result can be input into another OSA and coupler following the PPLN. The result can then be multicast by the PPLN into λ_{A} and λ_{B} (e.g., a first wavelength of the first data stream and a second wavelength of the second data stream) via cascaded nonlinear processes of sum frequency generation and difference frequency generation (SFG-DFG). For example, at a temperature of 45.1° C., quasi-phase-matching (QPM) wavelength of the PPLN waveguide can be set to 1551.3 nm to ensure efficient wave mixing. The total input optical power of the PPLN waveguide can be ˜24 dBm. Outputs of the multicasting stage 136 can include two multicast outputs (R_{A} and R_{B}). A result of the average operation can be broadcast back to one or more individual nodes that provided the first and second data streams via the PPLN. The result of the average operation can be a third data stream carrying a three-bit number and including a resolution greater than the resolution of the first or second data stream. The resolution being greater than the first or second data streams can result from the summation and digital average process. The result of the average operation can also be a 7-phase-encoded signal representing a three-bit number. In this case, the coherent receiver 140 can detect the 7-phase-encoded signal.

To ensure that wavelengths of the input data channels (e.g., the first laser source λ_{A} 102 and the second laser source λ_{B}) and the results are similar, the wavelengths of λ_{PA} and λ_{PC} are tuned and the QPM wavelength of the PPLN can be temperature tuned using a thermos-electric cooler. The coherent receiver 140 can be used for data recovery and decoding of different phase levels of the result (e.g., output signal).

In various embodiments, the digital average is not computed. The processing system 100 can include instead, for example, a half-adder (e.g., an optical half-adder). The half-adder can receive binary inputs and perform an XOR operation (e.g., Sum) and an AND operation (e.g., Carry) on the inputs. The half-adder can receive an optical signal according to two inputs (i.e., S_{A} and S_{B}) and two outputs (i.e., Sum and Carry). The half-adder can include an optical XOR gate to perform the Sum, and an optical AND gate to perform the Carry. The two inputs can be a first data stream and a second data stream and can be encoded with, for example, four phase levels. The two inputs (e.g., the first and second data streams) can be loaded by an AWG (e.g., the AWG 112). The first data stream can carry a first two-bit number mapped to one or more first quadrature-phase-shift-keying phases. The second data stream can carry a two-bit number mapped to one or more second quadrature-phase-shift-keying phases. The first and second data streams can be modulated by an IQ mod on two optical carriers as phase-encoded optical signals.

For example, the half-adder can receive an optical signal according to one or more phase-encoded inputs. For a 4-ary half-adder, the possible input and output states generated can include S_{A} {0, 1, 2, 3}, S_{B} {0, 1, 2, 3}, Sum {0, 1, 2, 3}, and Carry {0, 1} (e.g., binary inputs). The input and output states can be quaternary-based numbers and mapped to quadrature-phase-shift keying signals. For example, the half-adder can transform the optical signal according to a carry operation and a sum operation. An optics-based half-adder can be divided into two parallel processes: (i) Sum generation and (ii) Carry generation. The Sum generation can include modulo addition. At input, two phase-doubled subcarrier signals (A², B²) can be encoded with four phase levels

$$\{ \frac{π}{4} , \frac{3 π}{4} , \frac{5 π}{4} , \frac{7 π}{4} \} .$$

Subsequently, a corresponding output (A²B²) can be generated by adding together the phase of A² and B² (4 422=442+ (B²) with nonlinear wave mixing. The optical signal can be modulated at 10 to 20 Gigabaud rates, inclusive. For example, the two phase-doubled subcarrier signals can be encoded at 10 Gigabaud. A resulting output (i.e., Sum) can be represented by four phase levels

$$\{ \frac{π}{2} , π , \frac{3 π}{2} , 2 π \} .$$

when a symbol state of addition is <4 (e.g., 1+2=3), the output phase of A²B² can be simply added. When the symbol state of addition is ≥4 (e.g., 2+3=5), the output phase of A²B² can be added and “wrap around”. For instance, with the two inputs being 2 and 3 (corresponding phase levels of

$$\frac{5 π}{4} and \frac{7 π}{4} ) ,$$

the output phase A²B² can be added and “wrap around” to be π, corresponding to a state of 10.

For the Carry generation, the phase “wrap around” process can be tracked. In this case, two input pairs (A, B) and (A*, B*) can be utilized as follows: (i) two inputs (A, B) are encoded with four phase levels

$$( \frac{- 3 π}{16} , \frac{π}{16} , \frac{5 π}{16} , \frac{9 π}{16} ) ,$$

and the phases of A and B are added where the resulting states of λ_{B} are separated into the left and right halves of the phase diagram, (ii) to squeeze the added phase into two phase levels, A*B* is simultaneously generated from the two phase-conjugate inputs (A* and B*), and (ii) by coherently combining the optical field of λ_{B} and A*B*, the phase of the output (λ_{B}+A*B*) are squeezed into two phase levels {0, π} which corresponds to two states {0, 1}.

For example, the Carry generation can include generating a mapping of quaternary base numbers {0,1,2,3} to a pair of quadrature-phase-shift keying signals A and B with four phase levels of

$$( \frac{- 3 π}{16} , \frac{π}{16} , \frac{5 π}{16} , \frac{9 π}{16} )$$

for implementation in the optical half-adder. Then the Carry generation can then include generating, based on each of the pair of quadrature-phase-shift keying signals, a pair of pair-conjugate signals (A* and B*) with four phase levels of

$$( \frac{3 π}{16} , \frac{- π}{16} , \frac{- 5 π}{16} , \frac{- 9 π}{16} ) .$$

This can be done by, for example, phase-conjugate mirrors (PCMs) of the optical half-adder to perform the Carry or Sum operation in a nonlinear medium. Then, to form the two optical signals, the Carry generation can include generating, based on the pair of quadrature-phase-shift keying signals, a pair of phase-doubled signals A² and B² with four phase levels of

$$( \frac{π}{4} , \frac{3 π}{4} , \frac{5 π}{4} , \frac{7 π}{4} )$$

to form two optical signals S_{A} (A, A*, A²) and S_{B} (B, B*, B²).

To enable optical signal processing of the phase-encoded signals, the optics-based half-adder (e.g., optical half-adder, half-adder) can be implemented using nonlinear wave mixing (e.g., using PPLN). The optics-based half-adder can thus compute the Sum and Carry via nonlinear wave mixing using the PPLN. For example, the input (S_{A}, S_{B}) can contain three phase-encoded subcarrier signals A, A*, A² (B, B*, B²) which can be encoded with a same data sequence and generated with a frequency offset Δf between neighboring subcarrier copies. A, A* and A² (B, B* and B²) can be generated with a frequency offset of Δf. Through the cascaded SFG and DFG processing of the inputs (S_{A}, S_{B} and a pump laser P), the Sum and Carry can be simultaneously generated at different wavelengths. Specifically, the Carry can be generated by coherently combining the mixing terms λ_{B} and A*B* requires λ_{B} and A*B* to share the same phase noise. One way to implement this can be to generate A and A* (B and B*) from the same laser source sharing the same laser phase noise.

The subject matter described here sometimes illustrates different components contained within or connected to other components. It should be understood that such depicted architectures are illustrative, and many other architectures can be implemented to achieve the same functionality. In a conceptual sense, any arrangement of components that achieves the same functionality is effectively “associated” such that the desired functionality is achieved. Hence, any two components combined herein to achieve a particular functionality can be seen as “associated with” each other such that the desired functionality is achieved, irrespective of architectures or intermediary components. Likewise, any two components so associated can also be viewed as being “operably connected” or “operably coupled” to each other to achieve the desired functionality, and any two components capable of being so associated can also be viewed as being “operably couplable” to each other to achieve the desired functionality. Specific examples of operably couplable components include, but are not limited to, physically mateable and/or physically interacting components, and/or wirelessly interactable and/or wirelessly interacting components, and/or logically interacting and/or logically interactable components.

Implementations described as being implemented in software are not limited to it and can include implementations implemented in hardware or any combination of software and hardware unless otherwise specified herein. An implementation illustrating or describing a singular component is not limited to a singular component. The present disclosure can encompass other implementations, including a plurality of the same component, unless explicitly stated otherwise herein.

With respect to the use of plural and/or singular terms herein, those with skill in the art can translate from the plural to the singular and/or from the singular to the plural as appropriate to the context and/or application. The various singular/plural permutations may be expressly set forth herein for the sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.).

Although the figures and description may illustrate a specific order of method steps, the order of such steps may differ from what is depicted and described unless specified differently above. Also, two or more steps may be performed concurrently or with partial concurrence unless specified differently above. Such variation may depend, for example, on the software and hardware systems chosen and designer choice. All such variations are within the scope of the disclosure. Likewise, software implementations of the described methods could be accomplished with standard programming techniques with rule-based logic and other logic to accomplish the various connection, processing, comparison, and decision steps.

Those within the art will further understand that if a specific number of an introduced claim recitation is intended, such an intent will be explicitly recited in the claim, and the absence of such recitation, no such intent is present. For example, as an aid to understanding, the following appended claims may use the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations or two or more recitations).

Furthermore, in those instances where a convention analogous to “at least one of A, B, and C, etc.” is used, in general, such construction is intended in the sense that one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general, such construction is intended in the sense that one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms or both terms. For example, the phrase “A or B” will be understood to include the possibilities of “A” or “B” or “A and B”.

Further, unless otherwise noted, the use of the words “approximate,” “about,” “around,” “substantially,” etc., mean plus or minus ten percent.

The foregoing description of illustrative implementations has been presented for illustration and description purposes. It is not intended to be exhaustive or limiting concerning the precise form disclosed, and modifications and variations are possible in light of the above teachings or may be acquired from the practice of the disclosed implementations. It is intended that the scope of the invention be defined by the claims appended hereto and their equivalents.

What is claimed is:

1. A method comprising:
receiving, by an optical half-adder, an optical signal according to one or more phase-encoded inputs; and
transforming, by the optical half-adder, the optical signal according to a carry operation and a sum operation.

2. The method of claim 1, wherein the optical signal comprises a first data stream carrying a first two-bit number mapped to one or more first quadrature-phase-shift-keying phases.

3. The method of claim 1, wherein the optical signal comprises a second data stream carrying a second two-bit number mapped to one or more second quadrature-phase-shift-keying phases.

4. The method of claim 1, wherein the optical signal is modulated at a rate of 10-Gigabaud.

5. The method of claim 1, wherein the optical signal is modulated at a rate of 20-Gigabaud.

6. The method of claim 1, further comprising:
generating a mapping of quaternary base numbers {0,1,2,3} to a pair of quadrature-phase-shift keying signals A and B with four phase levels of
$$( \frac{- 3 π}{16} , \frac{π}{16} , \frac{5 π}{16} , \frac{9 π}{16} ) ;$$
generating, based on each of the pair of quadrature-phase-shift keying signals, a pair of phase-conjugate signals A* and B* with four phase levels of
$$( \frac{3 π}{16} , \frac{- π}{16} , \frac{- 5 π}{16} , \frac{- 9 π}{16} ) ;$$
and
generating, based on the pair of quadrature-phase-shift keying signals, a pair of phase-doubled signals A² and B² with four phase levels of
$$( \frac{π}{4} , \frac{3 π}{4} , \frac{5 π}{4} , \frac{7 π}{4} )$$
to form two optical signals S_{A} (A, A*, A²) and S_{B} (B, B*, B²).

7. The method of claim 1 further comprising:
loading, by an arbitrary waveform generator, data streams of two data channels; and
modulating, by an in-phase and quadrature modulator, the data streams of the two data channels on two optical carriers as phase-encoded optical signals.

8. The method of claim 6, wherein the optical half-adder computes a sum and carry via non-linear wave mixing of the optical signals (S_{A} and S_{B}) using a poled lithium niobate waveguide.

9. A method comprising:
obtaining, by a first device, a first data stream carrying a first two-bit number as a 4-phase encoded channel with phase levels of
$${φ}_{A} / 2 = ( 0 , \frac{π}{4} , \frac{π}{2} , \frac{3 π}{4} ) ;$$
obtaining, by a second device, a second data stream carrying a second two-bit number as a 4-phase encoded channel with phase levels of
$${φ}_{B} / 2 = ( 0 , \frac{π}{4} , \frac{π}{2} , \frac{3 π}{4} ) ;$$
encoding, based on one or more quadrature-phase-shift-keying phases, the first data stream and the second data stream as four-phase-encoded optical data channels;
computing, by an optically-assisted operation when nonlinear wave mixing the first and the second data streams, an average operation on encoded first and second data streams; and
multicasting, by nonlinear wave mixing, the result of the average operation.

10. The method of claim 9, wherein computing the average operation of the first and the second data streams comprises summing the phase levels of two optical data channels through a non-linear fiber.

11. The method of claim 9, wherein the result of the average operation is multicast at one or more original input signal wavelengths using a periodically poled lithium niobate waveguide and broadcast back to one or more individual nodes.

12. The method of claim 11, wherein the result of the average operation is multicast to wavelengths of the first and second data streams.

13. The method of claim 9, wherein the result of the average operation is a third data stream carrying a three-bit number and comprising a resolution greater than a resolution corresponding to the first or second data streams.

14. The method of claim 13, wherein the result of the average operation is a 7-phase-encoded signal representing a three-bit number.

15. The method of claim 14 further comprises:
detecting, using a coherent receiver, one or more different phase levels, and corresponding bit streams of the 7-phase-encoded signal.

16. A system comprising:
at least one memory; and
at least one processor configured to:
obtain a first data stream carrying a first two-bit number mapped to one or more quadrature-phase-shift-keying phases;
obtain a second data stream carrying a second two-bit number mapped to the one or more quadrature-phase-shift-keying phases;
encode, based on the one or more quadrature-phase-shift-keying phases, the first data stream and the second data stream in a 4-phase-shift-keying (4-PSK) modulation format;
transform the first and the second data streams to an average operation, and
multicasting a result of the average operation.

17. The system of claim 16, wherein transforming the first and the second data streams to the average operation, is performed by a highly nonlinear fiber (HNLF).

18. The system of claim 16, wherein multicasting the result of the average operation is performed by a periodically poled lithium niobate (PPLN).

19. The system of claim 16, wherein the result is multicast at a first wavelength of the first data stream and a second wavelength of the second data stream.

20. The system of claim 16, wherein transforming the first and the second data streams comprises dividing and summing the first and second data streams.
